(19) United States
(12) Patent Application Publication
(10) Pub. No.: US 2003/0000209 A1
(43) Pub. Date: Jan. 2, 2003

(54) Industrial installation and container for operational equipment

(76) Inventor: Peter Madl, Forchheim (AT)

Correspondence Address: HARNESS, DICKEY & PIERCE, P.L.C., P.O.BOX 8910, RESTON, VA, 20195, US

(21) Appl. No.: 10/168,479

(22) PCT Filed: Dec. 4, 2000
(86) PCT No.: PCT/DE00/04318

(30) Foreign Application Priority Data
Dec. 21, 1999 (DE) 19961809.7

(51) Int. Cl. F16D 31/02

(52) U.S. Cl. 60/456

(57) ABSTRACT

The invention relates to an industrial installation that comprises a certain number of installation components (2, 4, 6), a cooling circuit (8, 9, 10) as a reservoir for the thermal energy afforded during a process and a container (14) for operational equipment which is provided with an electric device (52) for operating the installation components (2, 4, 6). The container (14) for operational equipment is air-conditioned by an air-conditioning system (16) that is connected to the cooling circuit (8, 9, 10) The invention provides an installation that keeps the power requirement for the air-conditioning system (16) at a minimum by utilizing the energy present in the cooling circuit (8, 9, 10).

The invention relates to an industrial plant, in particular a power station for generating energy, having a container for operational equipment for operating plant components. The invention also relates to a container for operational equipment for such a plant.

To operate and control the plant, that is to say to operate plant components and plant processes, different electrical apparatuses are normally arranged in a room for operational equipment. The electrical apparatuses are, for example, items of electrical equipment such as a transformer, an apparatus for low-voltage distribution or for direct-current distribution, a rectifier, batteries, etc. The term “electrical apparatus” also refers to a complete control room facility. Since, in particular, complex instrumentation and control apparatuses for controlling the plant processes are also accommodated in the room for operational equipment, complicated cabling between the individual apparatuses in the room for operational equipment and with plant components and decentralized instrumentation and control apparatuses outside the room for operational equipment is necessary. The conventional plant concept in this case is that the electrical apparatuses are only installed on site in a fixed room for operational equipment integrated in a building section of the plant. Accordingly, the electrical apparatuses must be connected to one another in-situ on the plant. On account of personnel who are often inadequately trained, there is a relatively large potential for errors here.

The aim of more recent efforts has been to design rooms for operational equipment as containers for operational equipment which have standardized electrical apparatuses which are already connected to one another in a prefabricated manner in the container. The container for operational equipment is already assembled at the factory by trained personnel skilled in the art. For simple and faultless connection of the container for operational equipment in-situ, this container has in particular standardized connections. A container for operational equipment designed as a control-center portable cabin has been disclosed by the technical information brochure of Siemens AG (Germany), automation technology sector, date of publication 08/97, with the title “Leitstellenraumzelle in Fertigbauweise” [control-center portable cabin in prefabricated type of construction]. All the installations necessary for the operation of a control center are fitted in a prefabricated manner in this control-center portable cabin. This comprises both technical apparatuses and office facilities including sanitary facilities and conference rooms. The control-center portable cabin is delivered ready for operation and only needs to be connected in-situ to a few installation lines.

An air-conditioning system is required in order to ensure the operability of the container for operational equipment, this air-conditioning system keeping the temperature in the container at a desired value. Since a failure of the air-conditioning system may possibly lead to a failure of the apparatuses in the container and thus to a failure of the plant control, the air-conditioning system is normally of redundant design for safety reasons. This has the disadvantage of relatively high costs for the air conditioning. Conventional electrically operated air-conditioning systems are normally provided for the container, these air-conditioning systems being arranged on the roof of the container. Depending on the requisite air-conditioning capacity of the air-conditioning system, the power consumption varies and may have a noticeably adverse effect on the operating result of the plant.

This applies in particular to small plants for the generation of electricity, the generator output of which is limited in particular to 5 MW. This is because, on account of statutory requirements (power supply law), it is currently possible to achieve a relatively high price per energy unit for electricity generated with such small power plants. The aim is therefore to keep the power consumption inside the plant as low as possible, so that, with a limited generator output, a maximum proportion of the generated output can be fed into the network. The high power consumption caused in particular by the redundant design of the air-conditioning system noticeably reduces the efficiency of the plant. In this case, the expression “efficiency” refers to the proportion of the electrical output provided by the generator compared with the electrical output fed into the network.

The object of the present invention is to permit as high an efficiency of the plant as possible.

To achieve this object, according to the invention an industrial plant, in particular a power station for generating energy, has a number of plant components, a cooling circuit as a reservoir for thermal energy obtained during a plant process, and a container for operational equipment which is designed as a separate construction unit. At least one electrical apparatus for operating the plant components is arranged in the container for operational equipment. For air-conditioning the container for operational equipment, an air-conditioning system is provided which is connected to the cooling circuit.

The invention is based on the fundamental idea of having recourse to a cooling circuit present in the plant as a reservoir for the air-conditioning of the container for operational equipment. In this case, the term “reservoir” refers to a heat accumulator with a storage medium which is suitable for storing, that is for absorbing and delivering, thermal energy. Depending on the temperature level in the reservoir, this reservoir, for the air-conditioning of the container for operational equipment, may be used both for cooling and for heating. The decisive advantage of using a reservoir which is fed with thermal energy obtained during the plant process consists in the fact that the electrical energy required for the air conditioning is reduced virtually to zero. The energy required for the air conditioning is provided virtually from the “waste energy” obtained during the plant operation.

The design of the container for operational equipment as a separate construction unit has the advantage that the container for operational equipment can be brought to the plant in a prefabricated state and can be connected there quickly and simply to plant components without great installation outlay. The air-conditioning system is preferably already pre-installed in the container. In particular the commissioning times and thus the investment costs of the plant are favorably influenced by the container solution.

The cooling circuit with its cooling medium, in particular cooling water, is especially suitable as a reservoir. Such a cooling circuit is necessary in a multiplicity of plants for operating different plant components. In particular in a plant for generating thermal energy (power station) in which water is heated, the latter must be directed and cooled in a circuit for a sufficiently high efficiency. In the process, a not inconsiderable proportion of the thermal energy is generally given off to the environment, this proportion of thermal energy being advantageously used for operating the air-conditioning system.

In the plant for generating energy, a main cooling circuit and in addition a secondary cooling circuit with a reduced thermal capacity compared with the main cooling circuit are provided as a rule. Since the capacity is as a rule a multiple of the thermal capacity required for the air conditioning, the air-conditioning system—in particular for reasons of standardization—is preferably connected to this secondary cooling circuit. The secondary cooling circuit serves, for example, to cool turbine oil or to cool the generator.

The thermal capacity of the cooling circuit, that is to say the thermal capacity provided by the reservoir, is preferably substantially higher than that of the air-conditioning system. This ensures that the air-conditioning system does not influence the cooling capacity. With such dimensioning, the air-conditioning system can be fitted in existing plants without any problems.

In an especially simple and thus also robust and cost-effective configuration, the air-conditioning system preferably has a water/air heat exchanger. The thermal energy stored in the cooling water of the cooling circuit is therefore delivered via such a heat exchanger to the air in the container for operational equipment.

In an especially expedient configuration, the cooling circuit has both a heat source and a heat sink. This has the advantage that the cooling circuit acting as heat reservoir can be used both for heating and for cooling the container. To this end, the heat source and heat sink preferably have different temperatures. The heat source is formed in the cooling circuit in particular by the return of the cooling medium into a cooling tower, and the heat sink is formed by the feed of the cooling medium from the cooling tower.

To set a suitable capacity of the air-conditioning system, a switching unit is preferably provided, via which the air-conditioning system is connected to the heat source and the heat sink. In this case, the switching unit serves either to perform a switching operation between the heat source and the heat sink or to intermix the thermal energy provided in each case by the heat source and the heat sink in a suitable manner in accordance with the current requirements.

In a preferred design, a regulating device is provided, via which the capacity of the air-conditioning system is automatically set as a function of the temperature in the room for operational equipment. With this regulating device, the temperature in the room for operational equipment or in the container is therefore advantageously regulated to a predetermined desired temperature.

For as high a degree of flexibility as possible when setting up and when exchanging the container for operational equipment, this container is set up so as to be movable and to this end has travel means. These travel means are, for example, wheels or rollers or devices provided for attaching wheels or rollers. The container is preferably mounted on rails or stilts via wheels. This facilitates the positioning and in particular the exchange of the container. In particular, provision is made for standardized containers for operational equipment, so that the container for operational equipment can be exchanged for another in a simple manner. In the event of failure of electrical apparatuses, for example control apparatuses, arranged in the container, the latter can therefore simply be completely exchanged. The downtime of the plant is thus reduced to a minimum.

In an especially advantageous manner, the plant is designed for generating energy, the maximum electrical output which can be generated being limited to a few MW, in particular to 5 MW. In such a plant, the energy-saving configuration of the air-conditioning system becomes especially apparent. As a result, the efficiency of the plant, compared with the use of a conventional air-conditioning system, is increased and the operating result is improved. This is true in particular on account of the specifications applying to such small plants, according to which a high output per energy unit generated can be achieved.

According to the invention, the object is also achieved by a container for operational equipment which has an air-conditioning system and a connection for connecting the air-conditioning system to a cooling circuit as a reservoir for thermal energy obtained during a plant process.

Preferred embodiments of the container for operational equipment can be gathered from the subclaims. The container for operational equipment is characterized in particular by a modular and standardized construction. The expedient configurations and advantages recited with regard to the plant are accordingly also to be applied to the container.

An exemplary embodiment of the invention is explained in more detail below with reference to the drawing, in which:

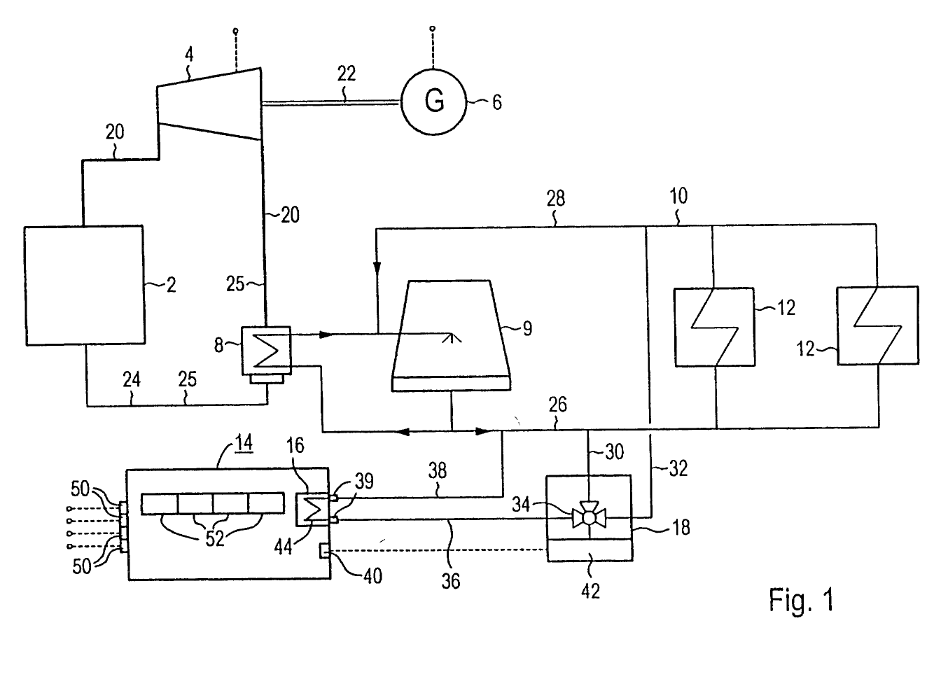

FIG. 1 shows a plant for generating energy in a schematic block diagram, and

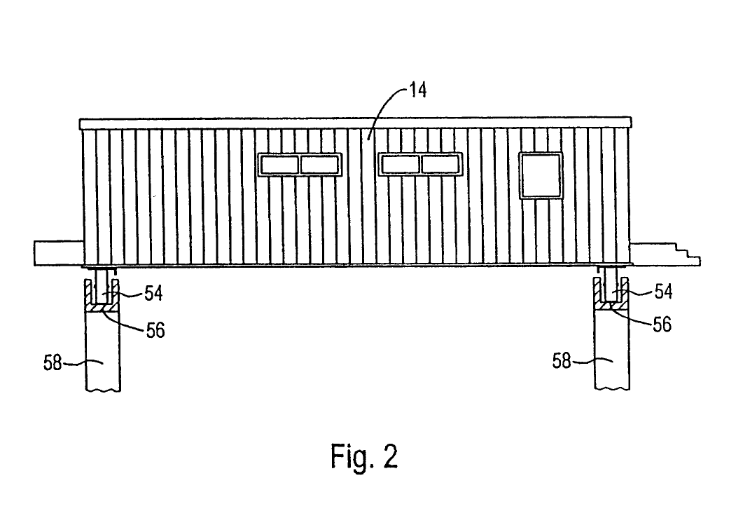

FIG. 2 shows a container for operational equipment set up so as to be movable on a travel means.

According to FIG. 1, a plant for generating energy comprises a thermal energy-generating unit 2, a turbine 4, a generator 6, a condenser 8, a cooling tower 9, a plurality of heat exchangers 12 arranged in a secondary cooling circuit 10, a container 14 for operational equipment with an air-conditioning system 16, and a switching unit 18 connected to the air-conditioning system 16. The thermal energy-generating unit 2 comprises, for example, a combustion chamber and a steam generator for generating steam. The latter is fed via a steam line 20 to the turbine 4 and drives the latter. The turbine rotation is transmitted via a shaft 22 to the generator 6 for generating electrical energy. The steam line 20 leads from the turbine to the condenser 8, where the steam is condensed. The condenser 8 is integrated in a main cooling circuit and is connected to the cooling tower 9 belonging to the cooling circuit. The steam condensed in the condenser 8 is fed as feedwater to the energy-generating unit 2 via a feedwater line 24.

The feedwater line 24 and steam line 20 form a water/steam circuit 25.

In order to prevent, for example, overheating of plant components, such as the generator 6 for example, during operation of the plant, the heat exchangers 12, via which the temperature of such plant components is regulated, are provided in the secondary cooling circuit 10.

The secondary cooling circuit 10 with integrated cooling tower 9 forms a reservoir for thermal energy. This reservoir draws its energy on the one hand from the plant process and on the other hand by heat exchange with the environment. The thermal energy contained in the reservoir is therefore provided essentially from waste heat from the energy-generating process. The secondary cooling circuit 10 has a feed 26 as heat sink and a return 28 as heat source. Typically, the feed temperature in the secondary cooling circuit 10 is 25° C. and the return temperature is 35° C.

Such moderate temperatures are especially suitable for the air-conditioning of the container 14 for operational equipment. The air-conditioning system 16 is therefore supplied with thermal energy from the secondary cooling circuit 10. To this end, cooling water is fed via the switching unit 18, which is connected to the feed 26 via a cold-water line 30 and to the return 28 via a hot-water line 32. The switching unit 18 comprises a valve 34, in particular a 3-way valve. With the latter, the air-conditioning system 16 can alternatively be supplied with hot water or with cold water or with a mixture, in order to achieve a suitable air-conditioning capacity of the air-conditioning system 16. The air-conditioning system 16 is connected to the switching unit 18 via a mixing line 36. This mixing line 36 is connected to the air-conditioning system 16 via a connection 39 on the container 14 for operational equipment. From a further connection 39, a return line 38 leads from the air-conditioning system 16 to the secondary cooling circuit 10.

Furthermore, a temperature sensor 40 is preferably arranged in the container 14 for operational equipment, this temperature sensor 40 being connected to a regulating device 42. The regulating device 42 controls the 3-way valve as a function of the measured actual temperature in order to set a desired temperature. The regulating device 42 in particular provides for automatic control of the temperature in the container 14 for operational equipment.

In order to keep the installation work in-situ on the plant to a minimum, the switching unit 18 and the regulating device 42 are preferably integrated in the container 14 for operational equipment. In this case, three connections 39 for pipelines are arranged on the container 14 for operational equipment, to be precise one for the cold-water line, one for the hot-water line and one for the return line. The mixing line 36 may be omitted in this case.

The connection between the air-conditioning system 16 and the secondary cooling circuit 10 makes it possible to both cool and heat the interior space of the container 14 for operational equipment. Since the air-conditioning system has recourse to residual or waste energy and to energy from the environment, it requires virtually no electrical energy. Electrical energy is only required in order to control it. It goes without saying that, depending on the type of plant, a heating circuit may also be used instead of a cooling circuit or in order to supplement the latter. If the container 14 for operational equipment is set up as a control room, the temperature is set as a rule to room temperature, that is to say to about 22° C. Since only temperatures within a range of between about 25° C. and 30° C. can be achieved as a rule with the air-conditioning system 16 via the secondary cooling circuit 10, an additional conventional air-conditioning system provided with low capacity is sufficient for this application in order to cool the temperature in the container 14 for operational equipment down to 22° C. Compared with conventional full-air conditioning, with a conventional air-conditioning system, the conventional air-conditioning system used here is of markedly smaller construction and need not be of redundant design. If it serves as an operational-equipment room for electrical components, the air-conditioning system 16 is set in such a way that the temperature does not exceed 35° C.

The air-conditioning system 16 has a simple water/air heat exchanger 44 of robust design, which is arranged in the container 14. The air conditioning is therefore effected by water cooling or water heating. This design, compared with conventional air-conditioning systems in which conditioned air is injected, is less susceptible to faults. In addition, due to this robust configuration, the air-conditioning system 16 is largely trouble-free and very easy to maintain. In addition to the low operating costs (low energy costs, low maintenance cost), only low installation costs arise due to the simple configuration.

Arranged in the container 14 for operational equipment are a plurality of electrical apparatuses 52 which, for operating and controlling the plant, are connected via plug-and-socket connections 50 to different plant components, such as, for example, the energy-generating unit 2, the turbine 4 and the generator 6. As a rule, the electrical apparatuses 52 are different components. For example, they form a control room facility and comprise the instrumentation and control or a switching system. They serve, for example, for the low-voltage distribution, for the direct-current distribution, for rectification and to this end are configured, inter alia, as transformers or batteries. The individual electrical apparatuses 52 are preferably prefabricated and standardized and are already cabled with one another before the container 14 for operational equipment is set up. On the plant, only the connection of the individual plant components is still necessary. To this end, the plug-and-socket connections 50 are standardized, that is to say in particular prefabricated and coded, so that incorrect connection is ruled out. In addition to the electrical apparatuses, an office facility (not show), for example, is also provided.

The electrical apparatuses 52 are preferably matched to one another and standardized in such a way that the container 14 for operational equipment can be used for different plants. The complicated, plant-specific configuring of the individual components of the container 14 for operational equipment is therefore dispensed with.

According to FIG. 2, the container 14 for operational equipment has travel means in the form of wheels 54, via which it is mounted on rails 56 in a movable and easily displaceable manner. The rails 56 are integrated in stilts 58, by means of which a clearance space is formed below the container 14 for operational equipment, and installation lines can be laid in this clearance space, in particular on “cable racks”. According to FIG. 2, the container 14 for operational equipment is arranged on the stilts 58 so as to be laterally displaceable. Alternatively, it can also be mounted so as to be displaceable in its longitudinal direction. On account of the set-up of the container 14 for operational equipment on rails 56, the container 14 can be pushed into position and pulled out in a simple manner, as a result of which its installation costs are kept low. In addition, this makes it possible, in combination with the standardization, to quickly exchange the complete container 14, as a result of which the downtime of the plant can be kept short in the event of a fault. A further advantage of the container solution with pre-installed electrical apparatuses 52 can be seen in the fact that the container 14 for the items of electrical equipment serves both as packing and as transport security and protects the electrical apparatuses 52 during the entire operating period of the plant.

1. An industrial plant, in particular a power station for generating energy, having a number of plant components (2, 4, 6), a cooling circuit (8, 9, 10) as a reservoir for thermal energy obtained during a plant process, and a container (14) for operational equipment which is designed as a separate construction unit and in which an electrical apparatus (52) for operating the plant components (2, 4, 6) is arranged, an air-conditioning system (16) connected to the cooling circuit (8, 9, 10) being provided for air-conditioning the container (14) for operational equipment.

2. The plant as claimed in claim 1, in which the air-conditioning system (16) is connected to a secondary cooling circuit (10) of the cooling circuit (8, 9, 10).

3. The plant as claimed in claim 1 or 2, in which the thermal capacity of the cooling circuit (8, 9, 10) is substantially higher than that of the air-conditioning system (16).

4. The plant as claimed in one of the preceding claims, in which the air-conditioning system (16) has a water/air heat exchanger (44).

5. The plant as claimed in one of the preceding claims, in which the cooling circuit (8, 9, 10) comprises a heat source (28) and a heat sink (26).

6. The plant as claimed in claim 5, in which a switching unit (18) is provided, via which the air-conditioning system (16) is connected to the heat source (28) and the heat sink (26) for setting the capacity of the air-conditioning system (16).

7. The plant as claimed in one of the preceding claims, in which a regulating device (42) is provided for setting the capacity of the air-conditioning system (16) as a function of the temperature in the room (14) for operational equipment.

8. The plant as claimed in one of the preceding claims, in which the container (16) for operational equipment is set up so as to be movable and to this end has travel means (46).

9. The plant as claimed in one of the preceding claims, which is designed for generating energy, the maximum electrical output which can be generated being limited to a few MW, in particular to 5 MW.

10. A container (14) for operational equipment for a plant as claimed in one of the preceding claims, which is equipped with an air-conditioning system (16) and with a connection (39) for connecting the air-conditioning system (16) to a cooling circuit (8, 9, 10) as a reservoir for thermal energy obtained during a plant process.

11. The container (14) for operational equipment as claimed in claim 10, in which the air-conditioning system (16) has a water/air heat exchanger (44).

12. The container (14) for operational equipment as claimed in claim 10 or 11, in which a regulating device (42) is provided for setting the heating/cooling capacity of the air-conditioning system (16) as a function of the temperature in the container (14) for operational equipment.

13. The container (14) for operational equipment as claimed in one of claims 10 to 12, in which prefabricated electrical apparatuses (52) are arranged.

14. The container (14) for operational equipment as claimed in claim 13, which has standardized plug-and-socket connections (50) for connecting the electrical apparatuses (52) to plant components (2, 4, 6).
